(19) United States
(12) Patent Application Publication
(10) Pub. No.: US 2013/0170840 A1
(43) Pub. Date: Jul. 4, 2013

(54) Hybrid Multi-Band Communication System

(71) Applicants: Jae Joon Chang, Johns Creek, GA (US); Youngsik Hur, Alpharetta, GA (US)

(72) Inventors: Jae Joon Chang, Johns Creek, GA (US); Youngsik Hur, Alpharetta, GA (US)

(73) Assignee: SAMSUNG ELECTRO-MECHANICS COMPANY, LTD., Gyunggi-Do (KR)

(21) Appl. No.: 13/560,324

(22) Filed: Jul. 27, 2012

Related U.S. Application Data
(60) Provisional application No. 61/512,902, filed on Jul. 28, 2011.

(51) Int. Cl. H04B 10/2575

(52) U.S. Cl. CPC H04B 10/2575
USPC 398/115

(57) ABSTRACT

A communication system includes a hybrid signal transmitter incorporating a signal routing circuit and a driver circuit. The signal routing circuit is configured to receive a first input signal and route the first input signal through a first signal path when the frequency bandwidth of the input signal is lower than a threshold frequency and through a second signal path when the frequency bandwidth exceeds the threshold frequency. The second signal path includes a frequency down-converter circuit. The driver circuit is configured to receive the routed input signal via the first signal path or the second signal path, and convert the routed input signal into an optical signal for coupling into an optical fiber.

### RELATED APPLICATION

The present application claims priority to U.S. Provisional Patent Application No. 61/512,902, filed Jul. 28, 2011, and entitled “ADAPTIVE HYBRID RADIO OVER FIBER (ROF) STRUCTURE FOR MULTI-BAND OPERATION,” which is hereby incorporated in its entirety as if fully set forth herein.

### DESCRIPTION OF THE RELATED ART

Various types of signal transmission media are typically selected on the basis of a frequency bandwidth associated with a signal. For example, human voice generally occupies a frequency bandwidth on the low end of the frequency spectrum, and consequently, voice signals can be propagated through wires such as a twisted pair of wires as used in wire-line telephony. On the other hand, television signals occupy a frequency bandwidth that is significantly higher than that of voice signals. As a result, television signals are propagated through a cable medium rather than twisted pair wire media, because the cable medium can transport the television signal over a greater distance with less distortion and attenuation in comparison to twisted pair wire media. However, cable media cannot optimally support the transportation of higher frequency signals such as microwave frequency radio signals that are transmitted over the air. As can be appreciated, each type of transmission medium has an associated advantage as well as associated handicaps such as performance trade-offs and cost trade-offs.

Attention is drawn to FIGS. 1 and 2 to provide elaboration upon a few of these trade-offs. FIG. 1 shows two types of transmission media that are used to propagate to a residence 125, a few signals of various bandwidths. Twisted pair wire-line medium 110 that connects Central Office (CO) 105 to residence 125, is used to transport telephone voice signals in combination with digital computer data.

Splitter 115 routes the low frequency telephone voice signals to a telephone 120 and routes the computer data (carried in a digital subscriber line (DSL) frequency bandwidth that is located above human voice bandwidth) to a computer 130. Unfortunately, twisted pair wire-line medium 110 places delivery distance constraints upon the DSL frequency bandwidth, therefore limiting delivery of computer data to a certain radius around CO 105. As can be understood, it would be preferable to expand this radius in order to provide computer data service (e.g. Internet access) to more customers and earn more revenue based on such delivery.

Turning now to the other transmission medium shown in FIG. 1, television signals (located in a frequency bandwidth well above the DSL frequency bandwidth) are beamed through free-space from a satellite-mounted dish antenna 145 to a terrestrial satellite dish antenna 150, from where the signals are conveyed to a television set 135 inside residence 125.

The free-space transmission medium places certain limitations such as signal loss and/or signal quality degradation as a result of obstacles (rain clouds, trees, buildings etc.) in the propagation path. Naturally, it would be preferable to transport the television signals while minimizing or eliminating some of these handicaps.

FIG. 2 shows a microwave communications system wherein radio signals at microwave frequencies are propagated in a line-of-sight free-space configuration between microwave transmitter 205 and several microwave receivers, such as receivers 215 and 220. This configuration suffers from certain handicaps. For example, receiver dish antenna 230 is located too far away from transmitter dish antenna 225 thereby leading to signal loss in microwave receiver 215. On the other hand, receiver dish antenna 235 is located within signal receiving range. But, in this case, the presence of obstruction 210 blocks the microwave signals transmitted from transmitter dish antenna 225 towards receiver dish antenna 235.

The handicaps explained above have been mitigated to some extent by exploiting the wide bandwidth characteristics of optical fiber for transporting a variety of signals that are combined together using various schemes (modulation schemes, multiplexing schemes etc). This alternative approach does provide certain advantages. However, these advantages are obtained at a price—specifically a high price associated with hardware, software and/or operating costs.

For example, in some instances, the use of expensive lasers and associated modulation circuitry may constitute a significantly high system cost. To elaborate upon this aspect, attention is drawn once again to FIG. 2, wherein microwave transmitter 205 may use a laser element coupled to a Mach-Zehnder modulator for generating a modulated microwave signal. Furthermore, while such a signal generation configuration at the transmitting end in itself contributes to high cost, the high cost burden is further exacerbated by necessitating each of microwave receivers 215 and 220 to house a corresponding laser receiver and demodulator circuitry. Thus, the system cost goes up in correspondence to the number of microwave receivers used for receiving the modulated microwave signal transmitted from microwave transmitter 205.

It is therefore desirable in view of the remarks above, that equipment cost, as well as equipment complexity, be minimized in wide bandwidth communication systems.

### SUMMARY

According to a first aspect of the disclosure, a communication system includes a hybrid signal transmitter incorporating a signal routing circuit and a driver circuit. The signal routing circuit is configured to receive a first input signal and route the first input signal through a first signal path when the frequency bandwidth of the input signal is lower than a threshold frequency and through a second signal path when the frequency bandwidth exceeds the threshold frequency, the second signal path including a frequency down-converter circuit. The driver circuit is configured to receive the routed input signal via the first signal path or the second signal path and convert the routed input signal into an optical signal for coupling into an optical fiber.

According to a second aspect of the disclosure, a communication system includes a hybrid signal receiver incorporating an optical-to-electrical converter and a signal routing circuit. The optical-to-electrical converter converts an optical signal to an electrical signal. The signal routing circuit receives the electrical signal and routes a baseband frequency portion of the electrical signal to a first output node, a radio-frequency (RF) portion of the electrical signal to a second output node, and an intermediate frequency (IF) portion of the electrical signal to a third output node.

According to a third aspect of the disclosure, a method of communication includes: down-converting a microwave frequency signal to an intermediate frequency (IF) signal; producing a hybrid signal by combining the IF signal with at least one of a) a baseband signal, or b) a radio frequency (RF) signal; converting the hybrid signal to an optical signal; and coupling the optical signal into an optical fiber.

Further aspects of the disclosure are shown in the specification, drawings and claims below.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts, or descriptively similar parts, throughout the several views and embodiments.

FIG. 1 shows a prior art communication system that includes a pair of transmission media for propagating signals of various bandwidths.

FIG. 2 shows a prior art microwave communications system in which microwave frequency signals are propagated in a line-of-sight free-space configuration.

FIG. 3 shows an exemplary hybrid multi-band communication system in accordance with the invention.

FIG. 4 shows a few exemplary signal transmission configurations that may be combined with each other to form a hybrid multi-band communication system in accordance with the invention.

FIG. 5 shows one embodiment of a hybrid multi-band transmitter that is a part of a hybrid multi-band communication system in accordance with the invention.

FIG. 6 shows an exemplary signal routing circuit that is a part of the hybrid multi-band transmitter shown in FIG. 5.

FIG. 7 shows a first exemplary embodiment of a hybrid multi-band communication system that incorporates a first set of components in accordance with the invention.

FIG. 8 shows a second exemplary embodiment of a hybrid multi-band communication system that incorporates a second set of components in accordance with the invention.

FIG. 9 shows a third exemplary embodiment of a hybrid multi-band communication system that incorporates a third set of components in accordance with the invention.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein. It will also be understood that the word “example” as used herein (in whatever context) is intended to be non-exclusionary and non-limiting in nature. Specifically, the word “exemplary” indicates one among several examples, and it must be understood that no special emphasis is intended or suggested for that particular example. A person of ordinary skill in the art will understand the principles described herein and recognize that these principles can be applied to a wide variety of applications using a wide variety of configurations and hardware elements.

The various embodiments described herein generally pertain to systems and methods related to a communication system that caters to multi-band signals by using a hybrid transmission approach. The multi-band signals include many different signals, ranging from baseband frequencies to microwave frequencies. At this point, it may be pertinent to point out that terms such as “baseband,” “radio frequency (RF)” and “microwave” that are used herein are not necessarily defined by a rigid range of frequencies, but are instead flexibly definable in the context of various applications.

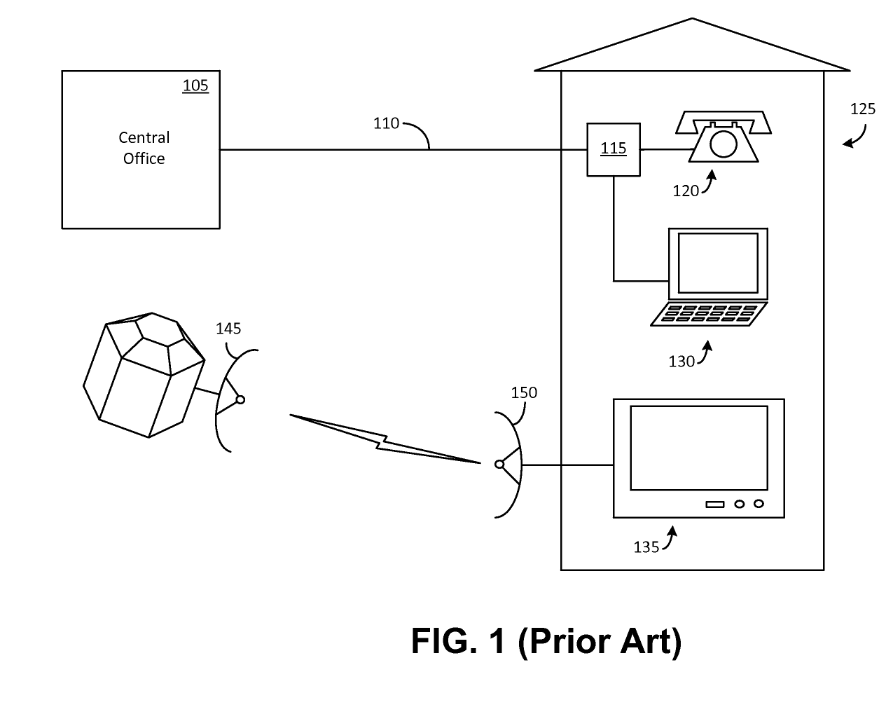

For example, when the various signals shown in FIG. 1 are combined in accordance with one exemplary embodiment of the invention, the voice frequency analog signals (telephone calls) may constitute the “baseband” signals, the DSL signals (computer data) may constitute the “RF” signals, and the high frequency signals (modulated satellite television signals) may constitute the “microwave” frequencies as referred to herein.

On the other hand, in another exemplary embodiment in accordance with the invention, analog or digital signals occupying a frequency spectrum below the very high frequency (VHF) band may constitute “baseband” frequencies, while signals in the VHF and ultra-high frequency (UHF) frequencies may constitute “RF” signals, and signals in the frequency spectrum above UHF frequencies (to whatever upper limit) may constitute the “microwave” frequencies, as referred to herein.

Furthermore, it should be notes that in accordance with a few embodiments described herein, 10 GHz has been used as a reference threshold frequency to delineate between “RF” frequencies and “microwave” frequencies. The choice of this particular frequency is motivated in part by the fact that in general prior art practice, 10 GHz typically constitutes a threshold frequency above which line-of-sight free-space communication is adopted, while frequencies below 10 GHz do not necessarily have to be propagated in a line-of-sight configuration.

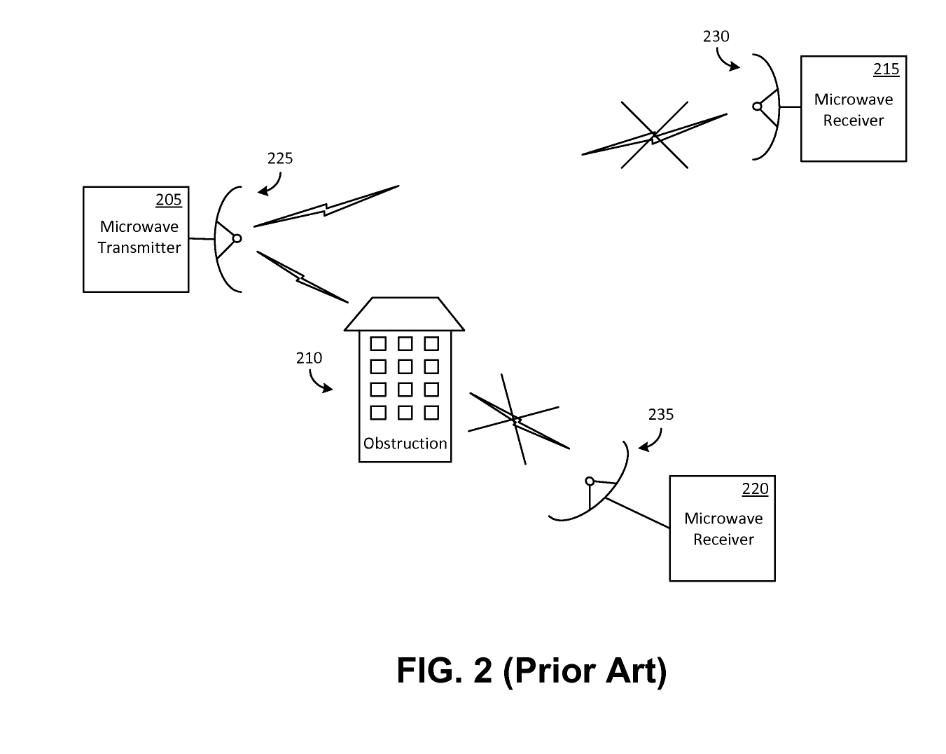

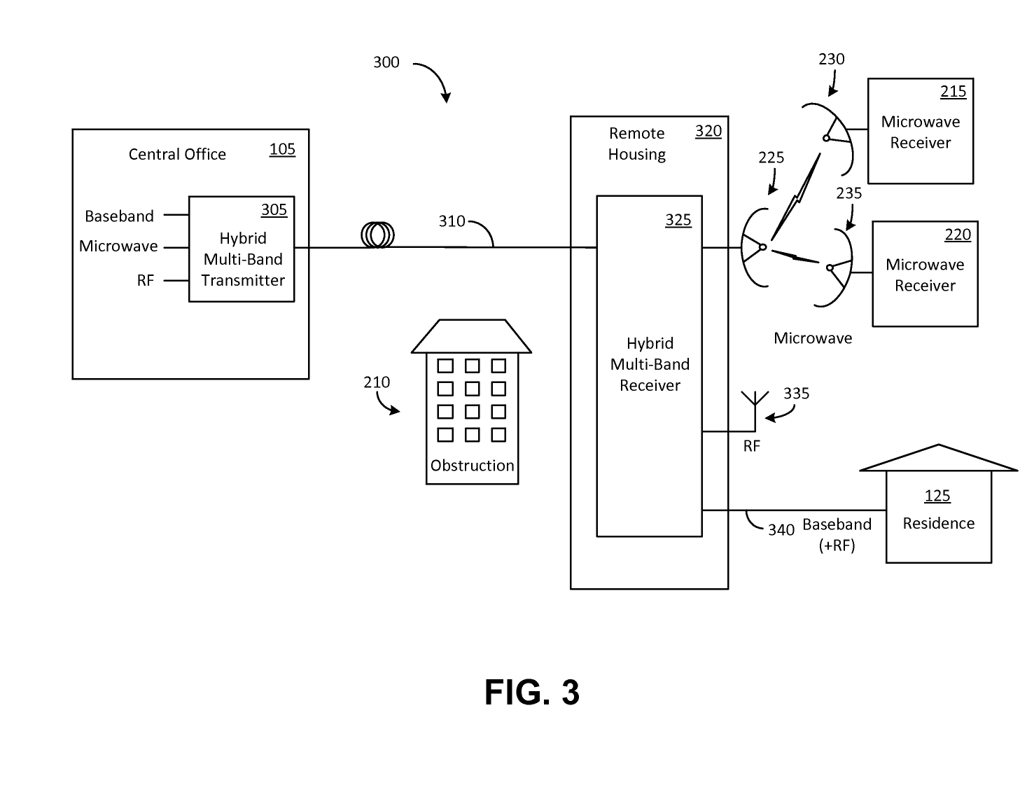

Attention is now drawn to FIG. 3, which shows an exemplary hybrid multi-band communication system 300 in accordance with the invention. This example, which includes certain elements that are shown in FIGS. 1 and 2, is used to illustrate how communication system 300 may be used in place of some prior art systems. However, it will be understood that communication system 300 may be used in a wide variety of applications that do not necessarily have any connection to the prior art systems shown in FIGS. 1 and 2.

Central Office (CO) 105 houses a hybrid multi-band transmitter 305 that accepts one or more signals occupying multiple frequency bands. An output port of hybrid multi-band transmitter 305 is coupled to an optical fiber 310, which may be a single-mode or a multi-mode optical fiber in accordance with a desired operational bandwidth. At the other end of optical fiber 310, a hybrid multi-band receiver 325 located in a remote housing 320, receives the one or more signals transmitted via the optical fiber 310 and routes the received signals to output ports that are coupled to suitable signal transmission elements (microwave dish antenna, RF antenna, coaxial cable etc).

To elaborate upon this configuration, a baseband signal that is provided to hybrid multi-band transmitter 305 may be combined with a radio frequency (RF) signal and/or a microwave signal that may also be provided to hybrid multi-band transmitter 305, before the combined signal is injected into optical fiber 310. The manner in which this combining is carried out (which is described below in more detail) leads to an improvement in signal reach and system performance, and may also contribute to reduced system costs.

As explained above with reference to FIG. 1, DSL operational reach is limited due to transportation over twisted pair wires. The prior art operational reach is significantly improved by using optical fiber 310, which can not only carry the RF signals (e.g. DSL frequencies) but also carry the baseband (telephone) frequencies over significantly greater distances with reduced attenuation and distortion.

Hybrid multi-band receiver 325 recovers the base-band frequency portion of the combined signal and transmits this baseband portion to residence 125, via transmission medium 340. Transmission medium 340 may be twisted pair wiring having the same length as the twisted pair of wires shown in FIG. 1, thereby extending the signal delivery area of the base-band portion by a length corresponding to that of optical fiber 310. As can be understood, the introduction of optical fiber 310 thus extends the overall delivery distance from CO 105 to residence 125 by a significant amount. When the RF signals shown in FIG. 3 are DSL signals, these RF signals may be combined with the baseband portion and the combination provided to residence 125 via the twisted pair of wires indicated by transmission medium 340. Alternatively, the RF signals may be transmitted to the residence 125 or other destinations, by using an RF antenna 335.

The microwave signal portion provided to hybrid multi-band transmitter 305 (and carried over optical fiber 310 along with the baseband and the RF frequency signals) is processed in hybrid multi-band receiver 325 before transmission out of microwave dish antenna 225 to receiver dish antennae 230 and 235. As can be seen the adverse effect of obstruction 210 between transmitter dish antenna 225 and receiver dish antenna 235 has now been eliminated. Also, the distance handicap between transmitter dish antenna 225 and receiver dish antenna 230 has also been eliminated.

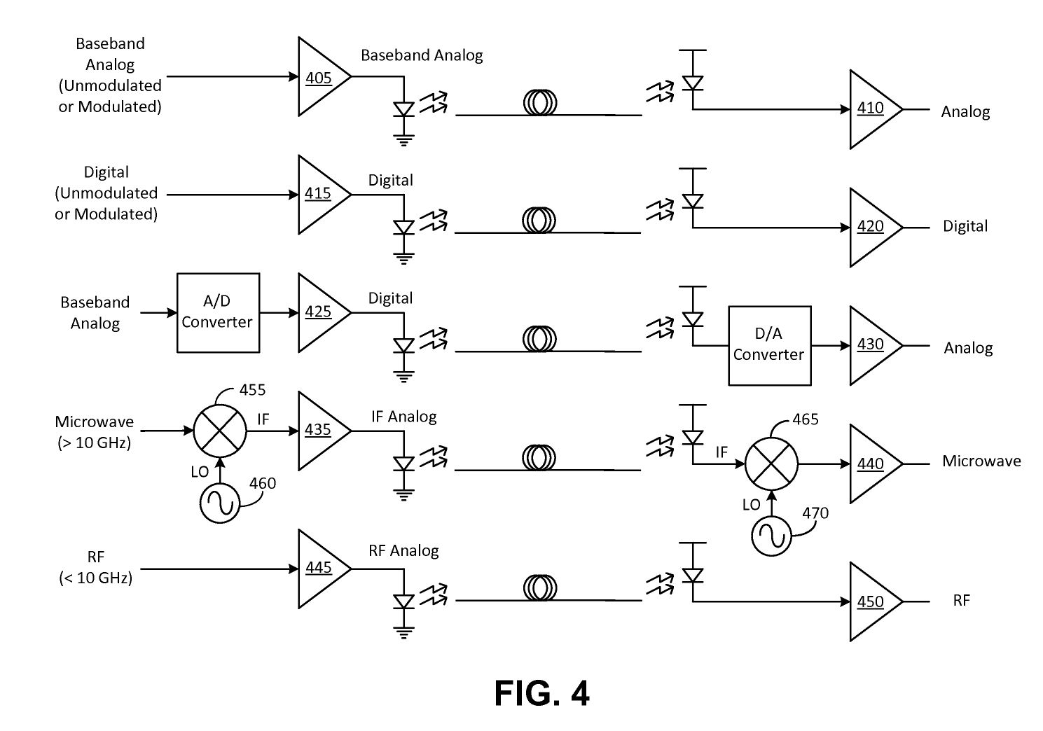

FIG. 4 shows a few exemplary signal transmission configurations that may be combined with each other to form a hybrid multi-band communication system in accordance with the invention.

In a first exemplary signal transmission configuration, signal driver 405 is configured to receive a baseband analog signal and drive the analog signal into an electrical-to-optical (E/O) converter circuit (symbolically indicated by a light emitting diode). In certain embodiments, the analog signal may be an unmodulated signal, while in certain other embodiments the analog signal may be a modulated analog signal. Depending upon the frequency bandwidth of the analog signal, a multimode optical fiber (for example, a plastic fiber) may be used thereby providing cost savings over a single-mode optical fiber (glass).

At the receiving end, the optical signal propagated out of optical fiber 310 is coupled to an optical-to-electrical (O/E) converter (symbolically indicated by an optical detector diode) that regenerates the analog signal in the electrical domain and provides the regenerated analog signal to receiver/driver 410. Receiver/driver 410 propagates the signal to other processing circuitry (not shown) that is explained below in more detail.

In a second exemplary signal transmission configuration, signal driver 415 is configured to receive a digital signal and drive the digital signal into an electrical-to-optical (E/O) converter circuit (symbolically indicated by a light emitting diode). In certain embodiments, the digital signal may be an unmodulated signal, while in certain other embodiments the digital signal may be a modulated digital signal. Depending upon the frequency bandwidth of the digital signal, the optical fiber used may be either a multimode or a single mode optical fiber.

At the receiving end, the optical signal propagated out of optical fiber 310 is coupled to an O/E converter (symbolically indicated by an optical detector diode) that regenerates the digital signal in the electrical domain and provides the regenerated digital signal to receiver/driver 420.

In a third exemplary signal transmission configuration, a baseband analog signal is digitized by using an analog-to-digital converter (A/D Converter) and the digitized signal is provided to signal driver 425. Signal driver 425 drives the digitized signal into an electrical-to-optical (E/O) converter circuit (symbolically indicated by a light emitting diode). Again, optical fiber 310 that is used in this configuration may be a multi-mode or a single mode optical fiber selected on the basis of the frequency bandwidth of the digitized signal.

At the receiving end, the optical signal propagated out of optical fiber 310 is coupled to an O/E converter (symbolically indicated by an optical detector diode) that regenerates the digitized signal in the electrical domain, and provides the regenerated digitized signal to a digital-to-analog converter (D/A converter). The D/A converter couples the recovered analog signal to receiver/driver 430.

In a fourth exemplary signal transmission configuration, a microwave signal is down-converted to an intermediate frequency (IF) by using a mixer 455. The mixing operation is carried out by using a local oscillator (LO) signal provided by a local oscillator 460. The generated IF signal is driven by signal driver 435 into an electrical-to-optical (E/O) converter circuit (symbolically indicated by a light emitting diode) that couples the IF signal into optical fiber 310.

In some applications, the frequency down-conversion operation permits the use of a lower bandwidth multi-mode optical fiber rather than a high bandwidth single mode optical fiber, thereby providing cost benefits.

However, in some other applications, it may be desirable to use a large bandwidth optical fiber 310 for various reasons. For example, it may be preferable to use a high bandwidth optical fiber when the IF signal bandwidth, individually, or in combination with the frequency bandwidth of other signals, results in a high bandwidth payload.

At the receiving end, the IF optical signal propagated out of optical fiber 310 is coupled to an O/E converter (symbolically indicated by an optical detector diode) that converts the IF optical signal to an IF electrical signal, and provides the IF electrical signal to a frequency up-converter circuit (implemented in this exemplary embodiment as a mixer 465 with an LO signal provided by a local oscillator 470). The up-converter circuit regenerates the microwave signal originally provided to mixer 455 at the transmitting end. The microwave signal is coupled from the up-converter circuit to receiver/driver 440.

Apart from savings in cost that may be obtained by using a low cost optical fiber as a result of the microwave-to-IF conversion, further savings may be obtained as a result of the IF frequency bandwidth permitting the use of low cost components in the O/E and E/O converters. For example, low cost light-emitting and light detecting elements (for example, a light emitting diode operating in the visible, infrared, or ultra-violet regions) may be used in place of expensive laser diodes and modulation circuitry (such as a Mach-Zehnder modulator).

Furthermore, as mentioned above, the microwave signal frequency bandwidth is definable in various ways depending upon a variety of applications. In one exemplary embodiment, signals that are higher than a threshold frequency of about 10 GHz may be classified as “microwave” signals, while frequencies lower than 10 GHz (but above baseband frequencies) may be classified as “RF” signals.

In a fifth exemplary signal transmission configuration, signal driver 445 is configured to receive an RF signal and drive the RF signal into an electrical-to-optical (E/O) converter circuit (symbolically indicated by a light emitting diode). In certain embodiments, the RF signal may be an analog signal that is less than 10 GHz but greater than the baseband signal bandwidth (for example, a voice band). In other embodiments, the RF signal may be a modulated digital signal that is modulated using one or more of a variety of modulation schemes.

Optical fiber 310 may be a multi-mode or a single-mode fiber depending on the overall bandwidth if the RF signal is combined with other signals in accordance with the invention. At the receiving end, the optical signal propagated out of optical fiber 310 is coupled to an O/E converter (symbolically indicated by an optical detector diode) that regenerates the digital signal in the electrical domain and provides the regenerated digital signal to receiver/driver 450.

In accordance with the invention, two or more of the five exemplary signal transmission configurations described above (as well as other configurations that are not described above) may be combined to form a hybrid signal that is used in a multi-band communications system as described below in more detail. The combining criteria may be based on a variety of factors, including cost.

For example, in a first hybrid signal forming approach, the baseband analog signal (described above using one of the signal transmission configurations) may be combined with the RF signal configuration (described above using another of the signal transmission configurations), leaving out the microwave signal processing circuitry because one particular application does not require the transportation of microwave signals.

A few other exemplary combinational configurations are described below using other figures.

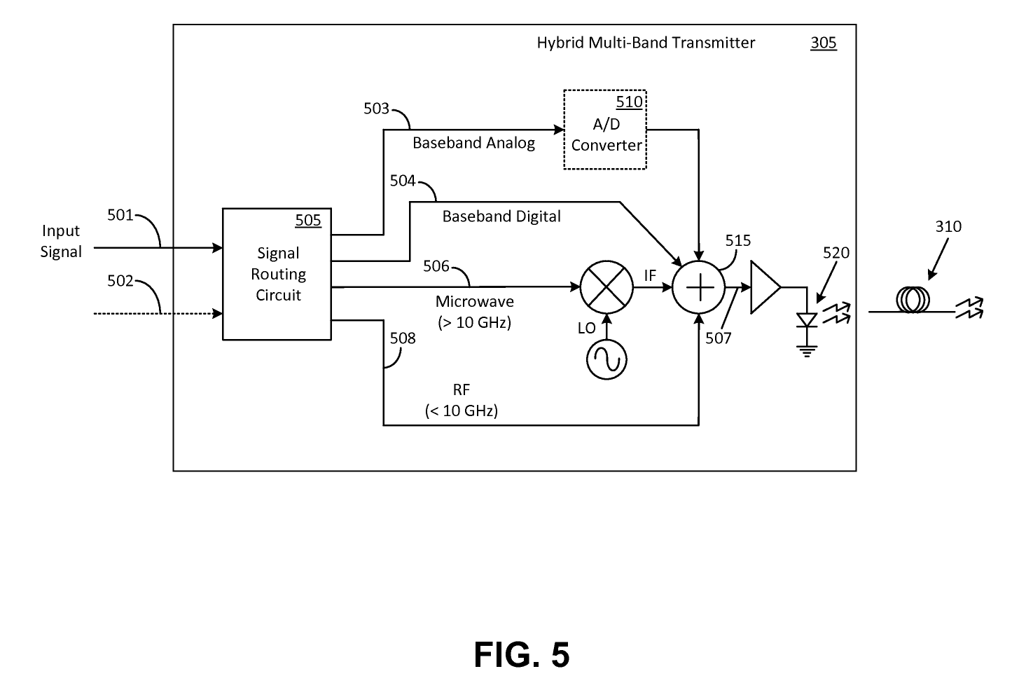

FIG. 5 shows an exemplary hybrid multi-band transmitter 305 that includes all five of the signal transmission configurations described above. It will be understood that only certain elements of hybrid multi-band transmitter 305 are shown in FIG. 5. Other elements, such as for example, signal receivers and signal amplifiers, have been omitted to as to avoid detraction from the primary features in accordance with the invention.

A first input signal is coupled into signal routing circuit 505 via link 501. In one exemplary application, this input signal occupies only one band amongst the various frequency bands described above. For example, in this exemplary application, the input signal may be a voice frequency band signal associated with a telephone call. (In addition to the first input signal coupled into signal routing circuit 505 via link 510, one or more additional input signals, for example, a microwave radio signal, may also be provided via additional links, such as link 502.)

In another application, the input signal provided via link 501 may include signals from multiple frequency bands. For example (referring back to link 110 of FIG. 1), the input signal on link 501 may include a voice frequency band signal, as well as an RF signal (DSL computer data).

In yet another application, the input signal may include a single large bandwidth input signal that spans for example, the RF as well as microwave frequency bands.

Notwithstanding the type of the input signal provided via link 501 (and link 502 etc.), signal routing circuit 505 routes the input signal into one or more of links 503, 504, 506 or 508 based on the frequency content of the signal.

When input signal is a baseband analog signal (or contains an analog baseband frequency component), the signal is routed to link 503 and from there on to signal combiner 515. Rather than propagating the baseband analog signal via optical fiber 310 in an analog format, it may be desirable in certain instances to propagate the baseband analog signal in digital form instead. When so desired, an A/D converter 510 may be used to convert the baseband analog signal into a digitized signal, which is then routed to signal combiner 515.

When input signal is a baseband digital signal, the signal is routed by signal routing circuit 505 to signal combiner 515 via link 504.

When input signal is a microwave signal (or contains a microwave frequency component), the signal is routed by signal routing circuit 505, via link 506, to a down-converter circuit as described above using FIG. 4.

When input signal is an RF signal (or contains an RF component), the signal is routed routing circuit 505 to signal combiner 515 via link 508.

Signal combiner 515 may be implemented in a variety of ways. For example, based on the frequency bandwidth of the combined output signal (on link 507), signal combiner 515 may be implemented using an operational amplifier configured as an adder, or may be implemented using a higher frequency RF combiner device such as a circulator, or an RF coupler.

The combined output signal on link 507 is suitably buffered and driven into the E/O converter circuit symbolically indicated by light emitting diode 520.

As will be understood the components of the E/O converter circuit may be selected on the basis of the frequency bandwidth of the combined output signal on link 507, with a simpler and cheaper circuit used when this frequency bandwidth is low enough to justify use of such simpler circuitry.

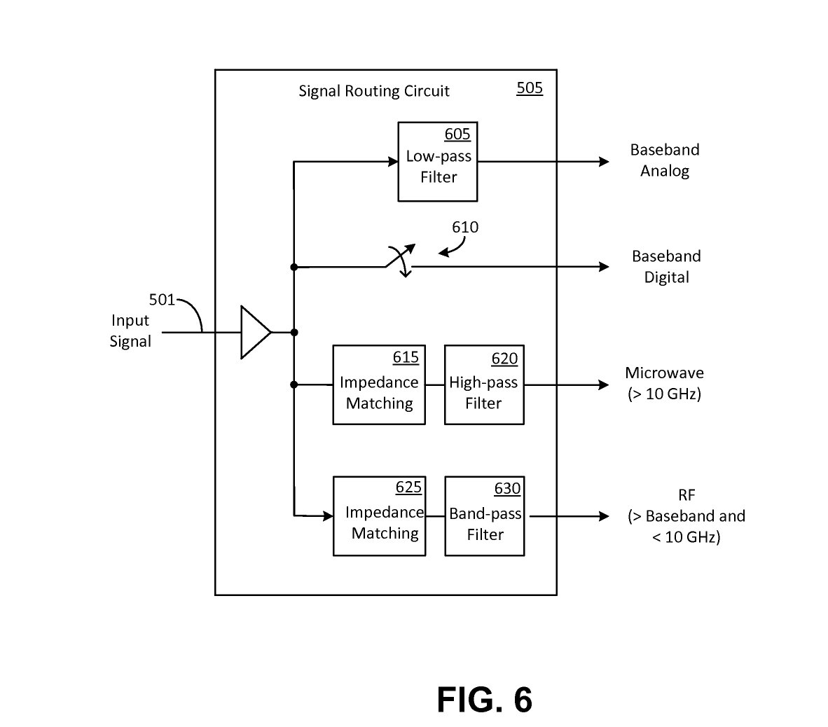

FIG. 6 shows an exemplary signal routing circuit 505 containing a few exemplary components. The input signal provided via link 501 may be a single signal covering a single band amongst the various frequency bands described above, or may be one or more signals having a bandwidth encompassing multiple frequency bands amongst the various frequency bands described above.

For example, in one application, the input signal may be a single wide-band signal straddling two or more frequency bands amongst the various frequency bands described above (baseband, RF and microwave). In another exemplary application, the input signal may be a multiplexed signal composed of a number of signals that are independent of each other, with each independent signal occupying one or more frequency bands amongst the various frequency bands described above.

Notwithstanding the nature of the input signal, signal routing circuit 505 routes the entire input signal, or respective portions of the input signal, based on the nature of the frequency content. Low-pass filter 605 is configured to selectively pass frequency components corresponding to the baseband analog frequency band. High-pass filter 620 is configured to selectively pass through frequency components corresponding to the microwave frequency band (for example, frequencies greater than 10 GHz). Band-pass filter 630 is configured to selectively pass through frequency components corresponding to the RF frequency band (for example, frequencies greater than baseband analog but less than 10 GHz).

Impedance matching circuits 615 and 625 may be used to provide optimal impedance conditions to allow routing of the microwave and RF portions to their respective filters. For example, in one application, impedance matching circuit 615 may be designed for optimally passing microwave frequencies but providing a sub-optimal impedance match to the RF frequencies, which are more optimally passed by impedance matching circuit 625.

Selector switch 610 may be selectively operated when the input signal is a baseband digital signal and it is undesirable to propagate this baseband digital signal through low pass filter 605.

Having described a few exemplary signal propagation paths, it will be understood that signal routing circuit 505 is a configurable circuit, wherein various portions may be omitted by not providing the hardware (the microwave portion, for example), or by selectively cutting out certain elements (such as the RF portion) by using switches (not shown). The configurable nature of signal routing circuit 505 allows for cost optimization over the prior art.

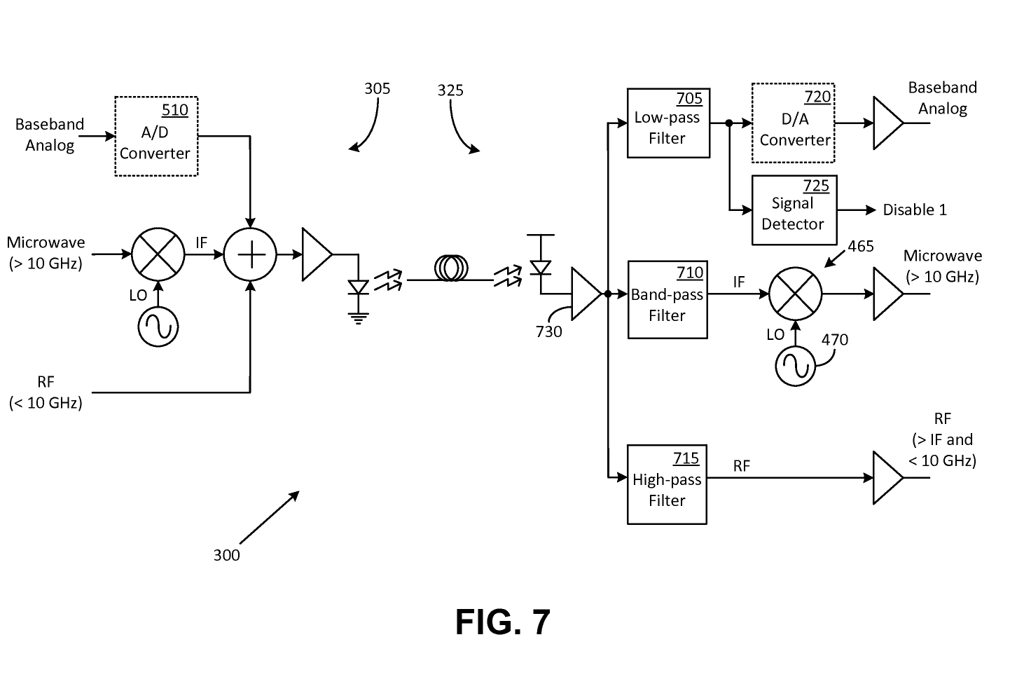

FIG. 7 shows a first exemplary embodiment of a hybrid multi-band communication system that incorporates a first set of components in accordance with the invention.

Attention is first drawn to hybrid multi-band transmitter 305, which includes a signal routing portion that has a different configuration in comparison to signal routing circuit 505 described above using FIG. 6.

More specifically, in contrast to the configuration shown in FIG. 6, wherein a single input signal may contain multiple frequency components (a multiplexed signal, for example) several individual input signals are provided in the configuration shown in FIG. 7. The individual input signals may be provided from different signal sources, or may be separated from a single signal source in a manner that is different than that used in signal routing circuit 505.

The operation of the various components of hybrid multi-band transmitter 305 may be understood from the description provided above vis-à-vis FIG. 6 and in the interests of brevity will not be repeated herein.

Turning to the receiver side of hybrid multi-band communication system 300, in this exemplary embodiment, hybrid multi-band receiver 325 is implemented using a set of filters that are provided with a received signal in the electrical domain (after O/E conversion has been carried out in order to convert the optical signal received from optical fiber 310 to the received signal in the electrical domain).

It will be understood that in other embodiments, one or more of these filters may be omitted, and additional elements such as selector switches, impedance matching circuits, and demodulators for example, may be introduced.

Low-pass filter 705 selectively propagates only the low frequency portion of the received signal, particularly the baseband portion (analog or digitized analog baseband), to a first output port of hybrid multi-band receiver 325. A/D converter 720 may be included when the low frequency portion is a digitized signal and it is desired to recover the analog version of this digitized signal.

Band-pass IF filter 710 selectively propagates only an IF portion of the received signal to an up-converter circuit 465 wherein a local oscillator 470 is used to up-convert the IF frequency back to the microwave frequency that was present in the input microwave signal provided to hybrid multi-band transmitter 305. The regenerated microwave signal is routed to a second output port of hybrid multi-band receiver 325. The IF portion may have any suitable center frequency and bandwidth in accordance with one or more applications that are served by hybrid multi-band communication system 300. In one exemplary embodiment, the IF portion is located between a baseband portion and an RF portion of the received signal without overlapping into either of these two other portions.

High-pass IF filter 715 selectively propagates only the high frequency portion of the received signal to a third output port of hybrid multi-band receiver 325. The high frequency portion is located above the IF frequency band.

Attention is now drawn to a signal detector circuit 725, which is shown coupled to an output side of low-pass filter 701. Signal detector circuit 725 may be implemented in several different ways. For example, in one application, signal detector circuit 725 is implemented as a threshold detector circuit incorporating one or more comparators. In another application, signal detector circuit 725 is implemented by using a diode (a silicon detector diode, for example) that converts the analog signal from an AC (alternating current) format to a DC (direct current) format. The detector output signal (DC) may then be routed to a threshold comparator circuit for example.

Irrespective of the manner in which signal detector circuit 725 is implemented, the output of signal detector circuit 725 may be used as a control signal for various purposes. For example, in some applications, this output signal may be used as a disable signal for disabling power provided to one or more elements of hybrid multi-band receiver 325. The disabling may be carried out by activating one or more switches (not shown), or by providing the disable signal at a suitable logic level to one or more integrated circuits or other devices (not shown) that have for example, a power-down mode or a sleep mode of operation.

In other embodiments, signal detector circuit 725 may be replaced by, or supplemented with, additional signal detector circuits (not shown) that are coupled to the output side of band-pass IF filter 710 and/or high-pass filter 715.

Furthermore, in some embodiments, a signal detector circuit may be located at the output side of buffer/driver 730 so as to detect the presence or absence of the received signal before being provided to any of the three filters. When such a signal detector detects an absence of the received signal, a control signal (which may be a disable signal) is generated and this control signal used for various purposes in hybrid multi-band receiver 325.

A few examples of these various purposes may include: a) disconnecting one or two of the three filters, thereby eliminating undesirable loading of the received signal (to minimize distortion in the RF signal and/or IF signal, for example), b) disconnecting power provided to one or more of the filters when these filters are implemented as active circuits (a digital signal processor (DSP) filter, for example), c) shutting down hybrid multi-band receiver 325, and/or d) placing hybrid multi-band receiver 325 in a sleep mode of operation.

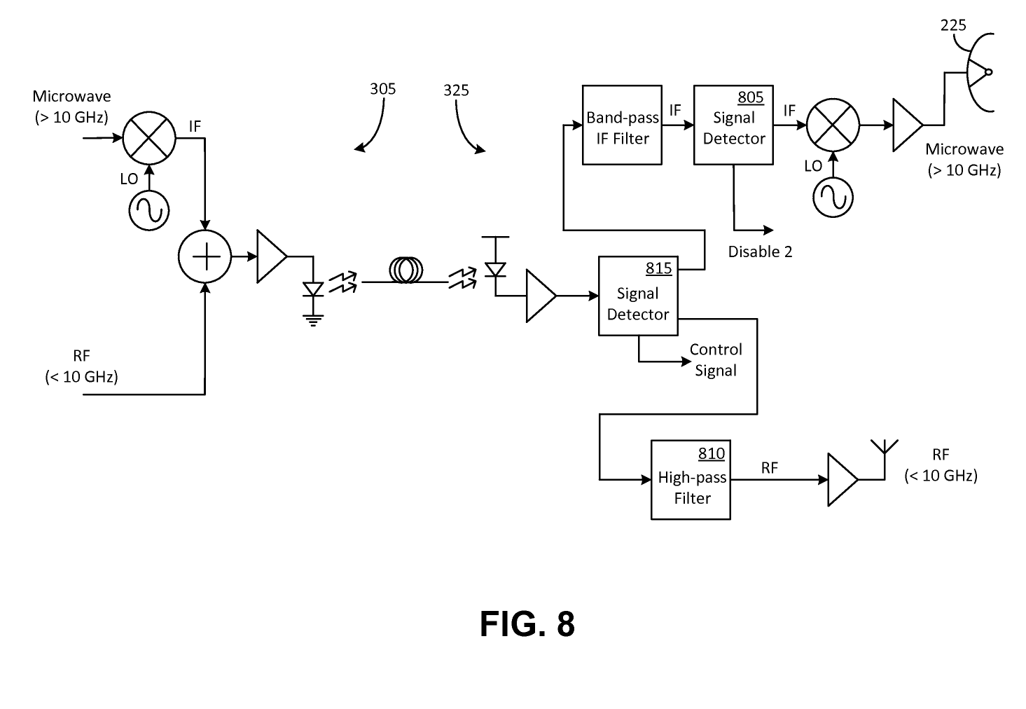

FIG. 8 shows a second exemplary embodiment of a hybrid multi-band communication system that incorporates a second set of components in accordance with the invention. Unlike the embodiment shown in FIG. 7, this embodiment includes only two signal paths, thereby providing certain cost benefits, some of which are described below.

In contrast to certain prior art systems, this configuration permits elimination of microwave demodulating circuitry in the hybrid multi-band receiver 325. The microwave signal generated in hybrid multi-band receiver 325 without the use of expensive demodulation circuitry, is a relatively close replica of the microwave signal provided as an input signal to hybrid multi-band transmitter 305. Though the input signal provided to hybrid multi-band transmitter 305 may be modulated using suitable modulation circuitry (not shown) that may be relatively expensive, the elimination of corresponding demodulation circuitry on the receive side in multiple hybrid multi-band receivers results in a reduction of overall system cost. (Referring back to FIG. 3, each of the multiple prior art receivers includes expensive demodulating circuitry). Attention is also drawn to signal detector circuits 805 and 815 which provide certain benefits as described above with reference to FIG. 7.

While FIG. 8 indicates an RF signal input into hybrid multi-band transmitter 305, in a different application, the RF input signal may be replaced with a digital signal and high-pass filter 810 suitably selected to encompass the digital signal bandwidth. In yet another application a digital signal may be combined with an RF signal and the combination signal propagated from hybrid multi-band transmitter 305 to hybrid multi-band receiver 325, wherein high-pass filter 810 is suitably selected to encompass the (digital+RF) signal bandwidth. Consequently, as can be understood, the same equipment may be interchangeably used for two or more different applications without major modification of circuitry.

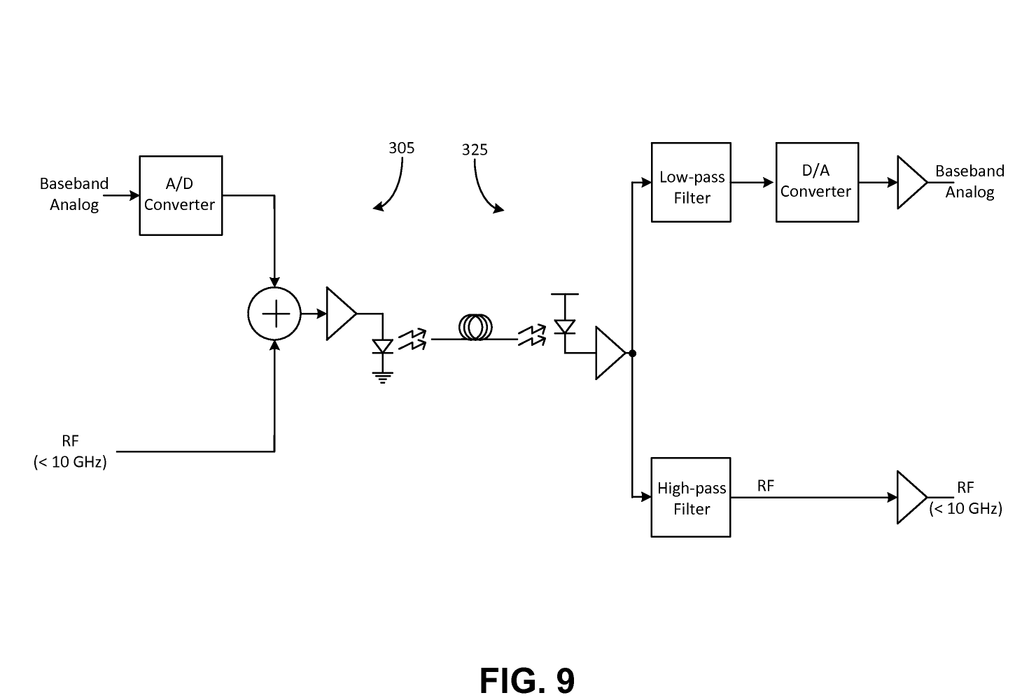

FIG. 9 shows a third exemplary embodiment of a hybrid multi-band communication system that incorporates a third set of components in accordance with the invention. Unlike the embodiment shown in FIG. 8, this embodiment omits the microwave portion, and instead includes a digitized analog portion. Omitting the microwave portion provides various cost benefits, as a result of various factors, such as, for example, replacing expensive RF circuit components with relatively inexpensive low-frequency components (such as low-frequency signal detector diodes in the O/E and E/O converter circuits).

While a few details have been provided using the three embodiments shown in FIGS. 7-9, it will be understood that additional circuitry, such as for example, circuits intended to provide redundancy in case of failures, may also be included. For example, the embodiment shown in FIG. 8 may include a secondary microwave signal path (not shown) that may be selectively included (by activating a switch for example) in case of failure of the primary signal path (shown).

The person skilled in the art will appreciate that the description herein is directed at explaining merely a few aspects of a hybrid multi-band communication system in accordance with the invention.

While the systems and methods have been described by means of specific embodiments and applications thereof, it is understood that numerous modifications and variations could be made thereto by those skilled in the art without departing from the spirit and scope of the disclosure.

Accordingly, it is to be understood that the inventive concept is not to be limited by the specific illustrated embodiments, but only by the scope of the appended claims. The description may provide examples of similar features as are recited in the claims, but it should not be assumed that such similar features are identical to those in the claims unless such identity is essential to comprehend the scope of the claim. In some instances the intended distinction between claim features and description features is underscored by using slightly different terminology.

What is claimed is:

1. A communication system comprising:
a hybrid signal transmitter, the hybrid signal transmitter comprising:
a signal routing circuit configured to receive a first input signal, and route the first input signal through a first signal path when the frequency bandwidth of the input signal is lower than a threshold frequency and through a second signal path when the frequency bandwidth exceeds the threshold frequency, the second signal path comprising a frequency down-converter circuit; and
a driver circuit configured to receive the routed input signal via the first signal path or the second signal path, and convert the routed input signal into an optical signal for coupling into an optical fiber.

2. The system of claim 1, wherein the first input signal is a radio frequency (RF) signal, and wherein the signal routing circuit is further configured to:
receive a microwave frequency signal;
route the RF signal through the first signal path; and
route the microwave frequency signal through the second signal path for down-converting the microwave frequency signal to an intermediate frequency (IF) signal.

3. The system of claim 2, wherein the signal routing circuit is further configured to receive a baseband frequency signal, and route the baseband frequency signal to the driver circuit through a third signal path.

4. The system of claim 3, wherein the driver circuit is configured to generate the optical signal by combining the baseband frequency signal, the RF signal, and the IF signal.

5. The system of claim 4, wherein the threshold frequency is about 10 GHz.

6. The system of claim 5, further comprising:
a hybrid signal receiver, comprising:
a signal receiving circuit configured to receive the optical signal from the optical fiber; and
a frequency up-converter circuit for converting the IF signal to an output signal at a microwave frequency corresponding to the microwave frequency signal.

7. The system of claim 6, wherein the signal receiving circuit is configured to generate a disable signal upon detecting an absence of at least one of the baseband frequency signal, the RF signal, or the IF signal.

8. The system of claim 7, wherein the disable signal is used to disable power provided to at least a portion of the hybrid signal receiver.

9. The system of claim 7, wherein the disable signal is used to disconnect at least one connection in the hybrid signal receiver.

10. The system of claim 1, wherein the first input signal comprises a baseband frequency portion and a microwave frequency portion, and further wherein the signal routing circuit is configured to route the baseband frequency portion through the first signal path and route the microwave frequency portion through the second signal path for down-converting the microwave frequency signal to an intermediate frequency (IF) signal.

11. The system of claim 7, wherein the threshold frequency is about 10 GHz.

12. A communication system comprising:
a hybrid signal receiver, the hybrid signal receiver comprising:
an optical-to-electrical converter for converting an optical signal to an electrical signal; and
a signal routing circuit configured to receive the electrical signal and route a baseband frequency portion of the electrical signal to a first output node, a radio-frequency (RF) portion of the electrical signal to a second output node, and an intermediate frequency (IF) portion of the electrical signal to a third output node.

13. The system of claim 12, further comprising a frequency up-converter circuit for converting the IF portion of the electrical signal to a microwave frequency.

14. The system of claim 13, further comprising a signal detector circuit for generating a disable signal upon detecting an absence of the intermediate frequency signal.

15. The system of claim 14, wherein the disable signal is used to disable power provided to at least a portion of the hybrid signal receiver.

16. The system of claim 15, further comprising:
a hybrid signal transmitter, the hybrid signal transmitter comprising:
a signal routing circuit configured to receive the baseband portion, the RF portion and a microwave portion, the signal routing circuit operable to route the baseband portion through a first signal path, the RF portion through a second signal path, and the microwave portion through a third signal path, the third signal path comprising a frequency down-converter circuit for down-converting the microwave portion to an IF spectrum for forming the IF portion; and
a driver circuit configured to combine the baseband portion, the RF portion and the IF portion, and convert the combination to the optical signal.

17. A method of communication, comprising:
down-converting a microwave frequency signal to an intermediate frequency (IF) signal;
producing a hybrid signal by combining the IF signal with at least one of a) a baseband signal, or b) a radio frequency (RF) signal;
converting the hybrid signal to an optical signal; and
coupling the optical signal into an optical fiber.

18. The method of claim 17, further comprising:
receiving the optical signal from the optical fiber;
converting the optical signal into an electrical signal;
recovering from the electrical signal, the IF signal and the at least one of the baseband signal and the RF signal; and
up-converting the IF signal to regenerate the microwave frequency signal.

19. The method of claim 18, wherein the optical signal is received in a hybrid signal receiver circuit, the method further comprising:
upon detecting an absence of the IF signal, reducing power consumption in the receiver circuit.

20. The method of claim 19, wherein the baseband signal is a digital baseband signal.
